(19) United States
(12) Patent Application Publication
(10) Pub. No.: US 2008/0189132 A1
(43) Pub. Date: Aug. 7, 2008

(54) Automatic Hospital Bed Accounting System

(76) Inventors: Matthew Minson, (US); Kelli Minson, (US)

Correspondence Address: Matthew Alan Minson M.D.;Kelli Lynn Minson, 1235 William Street, Baltimore, MD, 21230, US

(21) Appl. No.: 11/671,446

(22) Filed: Feb. 5, 2007

(51) Int. Cl. G06Q 50/00

(52) U.S. Cl. 705/2

(57) ABSTRACT

This automatic system, devoid of data entry requirement, is the only assurance of a current and immediately accurate means of determining bed availability. It would rely upon a method of automatic electronic entry of data when a patient is placed in a bed. Beds would be defined by preprogrammed electronic identifiers that would “describe” them with specificity (e.g. critical care, surgical/medical, etc.).

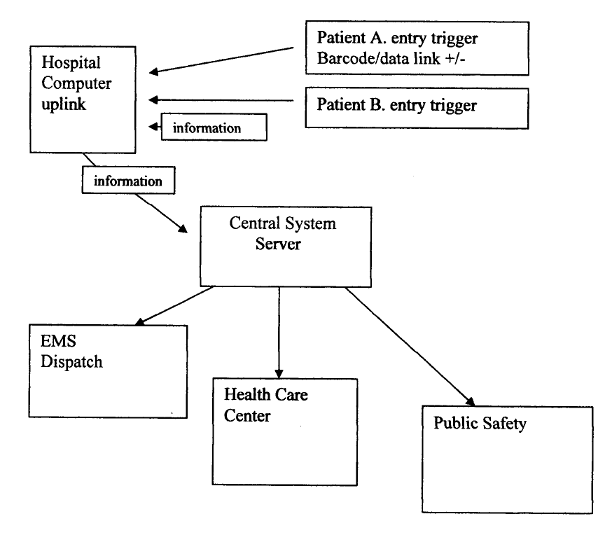

The availability of hospital bed capacity and capability information is one of the most challenging aspects to assuring a delivery of quality health and medical care to people. To determine the best destination to optimize a patient's outcome, the capacity (presence of an unoccupied type of hospital bed) and the capability (the equipment and specialty trained staff needed to provide a necessary level of care) of a hospital must be available to those making the decision. This is especially important for Emergency Medical Services (EMS) and Public Safety dispatchers, who advise individual units that are carrying patients with critical medical problems. This is especially important when a patient's medical condition requires a short time to definitive treatment. On a larger scale, healthcare systems are becoming more and more stressed by patient need and limited bed availability. During periods of high hospital use (pandemics, epidemics, mass casualty incidents) efficient coordination and assignment of destination is extremely important in limiting morbidity and mortality. Currently there are a number of systems that attempt to update bed occupancy, and hospital “diversion” status. These systems rely on individuals within the respective hospitals to manually update the hospital's information to a shared data bank. This current data entry system is extremely vulnerable and unlikely to be current during a disaster or during high demand. What is needed is an automated bed count system, which automatically uplinks and uploads a signal indicating a bed's occupancy.

### DESCRIPTION OF DRAWINGS

Patient A and Patient B blocks represent an occupied or unoccupied bed in a hospital room. When a patient is admitted to a bed in that room, a bar code or other light triggered identifier for that particular bed (bed A or bed B) is scanned or recorded automatically into the Hospital Bed Accounting System with a barcode or light triggered identifier. The information from that hospital or unit is then transferred in real time to the Central System Server which then makes the Bed Accounting (Beds Occupied/Beds Unoccupied) information for that particular hospital available on line to different agencies involved in emergency events that require immediate intelligence of hospitalization potential for large numbers of patients (which requires accurate accounting of all available and unavailable Hospital Beds) These could include EMS Dispatch, Health Care Centers, Public Safety and others.

1. An automatic identifier “trigger” (bar code, sequence identifier, radio frequency) of occupancy would initiate whenever a patient was assigned to a bed and would “mark” in the system as “occupied”.

2. The “mark” could be tied to a manual entry as in a bar code swipe or tied to entering registration so that a redundancy exists.

3. The “mark” would automatically upload to a central computer server and be communicated in real time to any subscribing or connected dispatch center computer terminal.

4. The bed typing would be pre-programmed or correspond to a bar code or other identifier so that the computer and system would automatically determined the bed, type, and number of availability upon being triggered (barcode swipe, or other electronic signal such as a chip).

5. Numerous facilities would be electronically linked and the updating of the system would occur instantly.

6. The bed type and number will change as patients are assigned and occupy the beds

7. Conversely when a patient ceases to occupy a bed (death, or discharge or transfer) the system alters correspondingly.

8. This change in status follows the same pattern of entry as occupancy and shows in the system and on computer screens in the same fashion.

9. This system would allow real time updating of bed type and occupancy.

10. A dynamic computer screen capacity would show the bed type changes in a moment by moment basis without the need for manual data entry.

11. This system could be expandable to an unlimited number of facilities and would be especially valuable during a disaster or pandemic.
